(19) United States
(12) Patent Application Publication
(10) Pub. No.: US 2004/0243770 A1
(43) Pub. Date: Dec. 2, 2004

(54) Data transfer system

(75) Inventor: Takashi Fujiwara, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/720,133

(22) Filed: Nov. 25, 2003

(30) Foreign Application Priority Data
May 28, 2003 (JP) P2003-151381

(51) Int. Cl. G06F 12/00

(52) U.S. Cl. 711/151

(57) ABSTRACT

An aspect of the present invention provides a data transfer system that includes a plurality of requesters configured to send data transfer requests, the requesters configured to transfer data when authorized, a transfer controller configured to receive the data transfer requests from the requesters, the transfer controller configured to authorize one of the data transfer requests to perform arbitration for the data transfer requests, the transfer controller configured to send a transfer directive at a predetermined timing, a network configured to receive the transfer directive to transfer data from an authorized requester based on the transfer directive, and a plurality of memories including a plurality of modules, each of the modules having data input and output unit, the memories configured to receive the transfer directive to receive transfer data from the network based on the transfer directive.

### CROSS REFERENCE TO RELATED APPLICATIONS

This application is based upon and claims the benefit of priority from the prior Japanese Patent Application No. P2003-15381 filed on May 28, 2003, the entire contents of which are incorporated herein by reference.

### BACKGROUND OF THE INVENTION

1. Field of the Invention

The present invention relates generally to a data transfer system, and more particularly, to a technology used when a plurality of requesters access memories through a common network.

2. Description of Related Art

FIG. 11 is a block diagram of a first example of a data transfer system of the related art. As shown in the figure, the requesters 102a, 102b, 102c, and 102dare connected to a network 101. When the requesters access memories 105a, 105b, 105c, and 105d through the network 101, they first send a request signal requesting to use the network 101 to a network arbiter 103. The network arbiter 103 allocates a network connection of the network 101 to the requesters based on a round robin or another algorithm. Requesters successful in obtaining an allocation are sent an authorization signal giving them authorization to use the network 101. Requesters that have obtained authorization to use the network 101 can send commands and data (in the case of writing data to memory) to a prescribed memory controller among memory controllers 104a, 104b, 104c, and 104d. Then, the memory controller that received the command executes reading and writing control of the memory such that data is written to the memory or read from the memory.

The problem with the data transfer system of the first related art is that when data is to be written to a memory, the data controller must hold the data in a buffer until it is actually time to write the data to the memory. Meanwhile, when data is to be read from a memory, the network connection is occupied until the memory controller reads the data. One method of solving the problem of occupying the network is the split transaction method, but similarly to the writing problem, this method requires the memory controller to hold the data being read until the requester accesses the network again. When transmitting (burst transferring) large volumes of data at once for image processing, streaming, or the like, the large-volume buffer used by the memory controller to hold the data tends to increase the surface area of the memory controller.

FIG. 12 is a block diagram showing a data transfer system of the second related art. This example illustrates a configuration in which the memory controller units do not have buffers. In this data transfer system, requesters 107a, 107b, 107c, and 107d send read commands to prescribed memory controllers among the memory controllers 109a, 109b, 109c, and 109d. The memory controller that receives each command complies with the command and controls the associated memory, i.e., memory 110a, 110b, 110c, or 110d, so as to read the data. Since the memory controller can detect the status of the memory, it sends a transfer request asking for authorization to use the network to the network arbiter 108 in synchronization with the timing at which the data can be read from the memory. An intermediate buffer is unnecessary because the system is configured such that the data is not read from the memory until authorization to use the network 106 for data transfer is obtained. In other words, the memory itself serves as the intermediate buffer. Similarly, when writing data to a memory, a requester sends a command to a memory controller and the memory controller delivers a write command to the memory. Since the actual writing of the data takes place later, the memory controller requests transfer authorization from the network arbiter 108 in synchronization with the timing at which the data can be written to the memory. Then, when the authorization is obtained, the memory controller extracts the data from the requester and writes it to the memory.

The data transfer system of the second related art enables the buffer to be eliminated, but it still has a problem in that even if the memory is in such a state that data can be read from it, the memory cannot be accessed until authorization to transfer through the network is obtained. When the memory has a plurality of banks, this results in poor access efficiency. Meanwhile, regarding writing data, when the time from delivering the command to the memory until the data can actually be written is shorter then the latency of the network, e.g., when the latency of the network is extremely long, the system will fall into a state in which the data has not yet arrived even though the memory is ready for the data to be written. Thus, a problem similar to that in the case of reading data occurs because the memory cannot be accessed.

### SUMMARY OF THE INVENTION

An aspect of the present invention provides a data transfer system that includes a plurality of requesters configured to send data transfer requests, the requesters configured to transfer data when authorized, a transfer controller configured to receive the data transfer requests from the requesters, the transfer controller configured to authorize one of the data transfer requests to perform arbitration for the data transfer requests, the transfer controller configured to send a transfer directive at a predetermined timing, a network configured to receive the transfer directive to transfer data from an authorized requester based on the transfer directive, and a plurality of memories including a plurality of modules, each of the modules having data input and output unit, the memories configured to receive the transfer directive to receive transfer data from the network based on the transfer directive.

### BRIEF DESCRIPTION OF THE DRAWINGS

FIG. 1 is a block diagram showing an embodiment of a data transfer system.

FIG. 2 is a diagram for explaining the major cycle.

FIG. 3 is a diagram for explaining pipelining of the transfer processing using the major cycle.

FIG. 4 is a timing chart for explaining the processing of each part of the data transfer system in this embodiment.

FIG. 5 is a block diagram for describing the details of the transfer controller of this embodiment.

FIG. 6A shows a table of data transfer requests received from requesters and FIG. 6B serves to explain the processing executed by a module arbiter.

FIG. 7A shows a table of data transfer requests received from requesters and FIG. 7B serves to explain the processing executed by the network arbiter.

FIG. 8 is a block diagram for explaining the details of the transfer controller in a second embodiment.

FIG. 9 is a block diagram for explaining the details of the transfer controller in a third embodiment.

FIG. 10 is a block diagram for explaining the details of the transfer controller in a forth embodiment.

FIG. 11 is a block diagram of the data transfer system of the first related art.

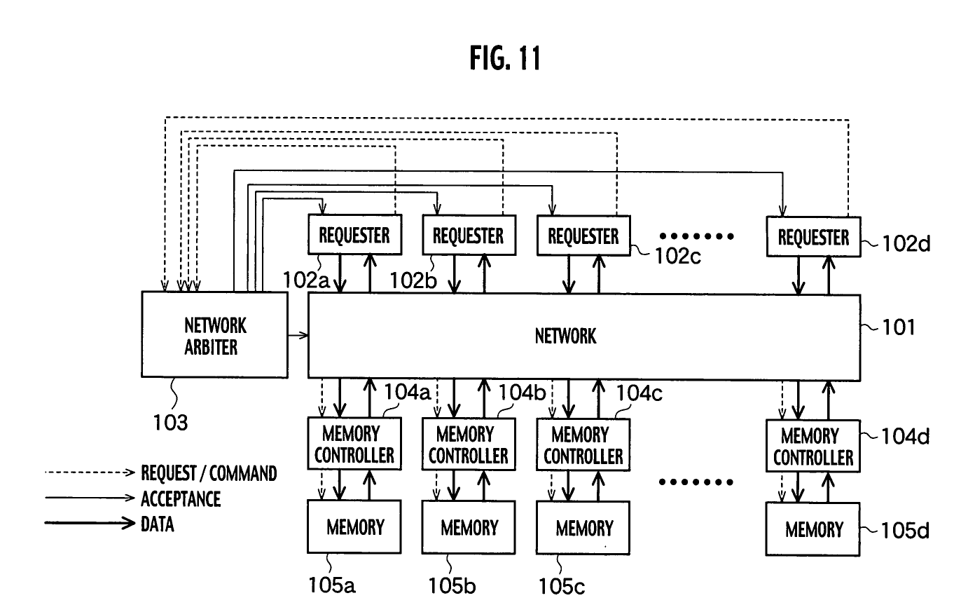

FIG. 12 is a block diagram showing the data transfer system of the second related art.

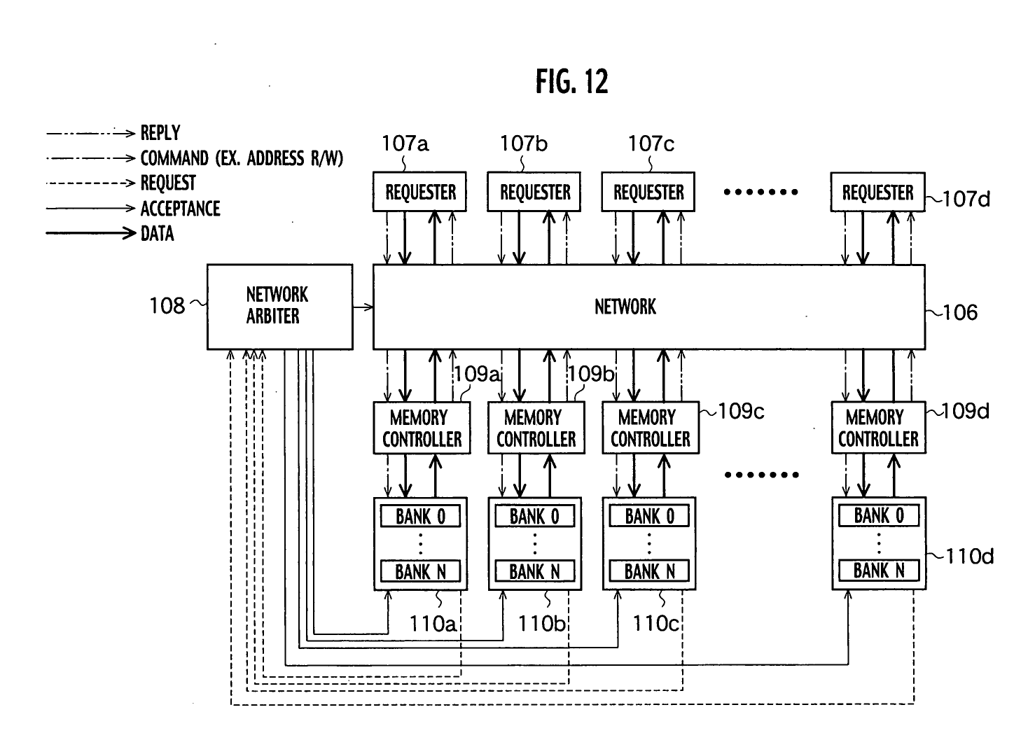

### DETAILED DESCRIPTION OF EMBODIMENTS

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

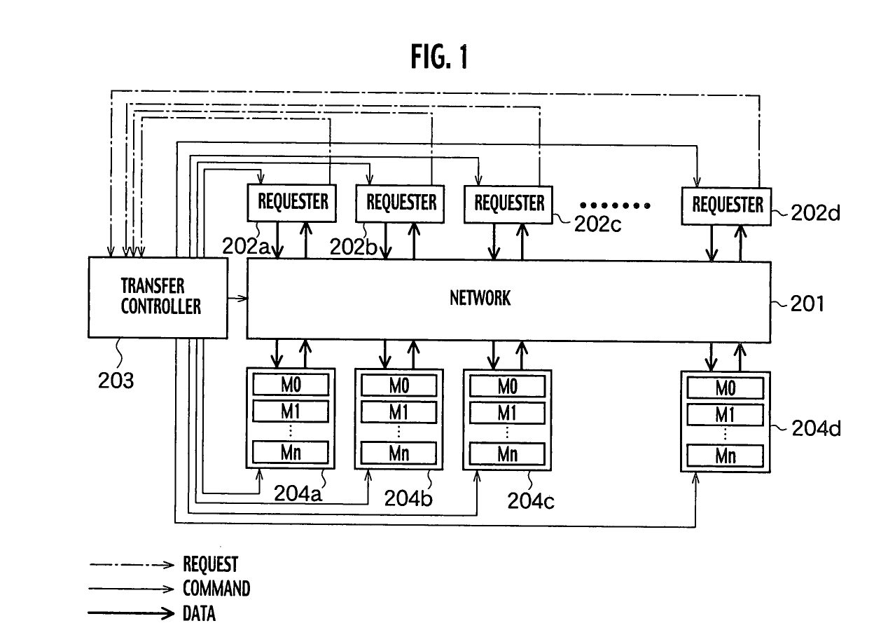

FIG. 1 is a block diagram showing an embodiment of a data transfer system. This data transfer system includes the following: a network 201 for transferring various types of data; requesters 202a, 202b, 202c, and 202d; and memory modules 204a, 204b, 204c, and 204d, each having a plurality of macros (0 to n, where n is an integer greater than or equal to 1).

The network 201 is connected to the requesters, a transfer controller, and the memory modules and functions to transfer data to prescribed memory modules in accordance with requests from the requesters. The network 201 is configured to use cross bar switching or a multiple bus structure.

Each requester is connected to the network 201 and to the transfer controller 203. The requesters send data transfer requests to the transfer controller 203 and, when they receive authorization, the requesters transfer data to prescribed memory modules.

The transfer controller 203 is connected to the network 201, the requesters, and the memory modules and functions to accept requests for data transfer from the requesters and give authorization to transfer data to prescribed requesters. The transfer controller 203 simultaneously performs both arbitration of the network 201 and arbitration of the memory modules in consideration of the macros. In this embodiment, memory modules having a plurality of macros are used.

The memory modules are connected to the network 201 and the transfer controller 203 and function to send and receive data to and from a prescribed requester through the network 201. Each memory module is provided with a plurality of memory regions called “macros.” Embedded DRAMs, i.e., DRAMs that are imbedded in an IC circuit, can be used for these memory modules. The data are divided and are stored by the macros.

Although the response time of a given macro when it is accessed is a prescribed number of cycles (e.g., random cycle time (tRC)=32 cycles), the apparent number of cycles required for access can be reduced by having a plurality of interleaved macros in a single memory module. For example, if the number of macros in a memory module is four (N=4), then the apparent tRC can be reduced to eight cycles by skillfully controlling access to the macros.

Next, the operation of the data transfer system of this embodiment will be described. First, the transfer controller 203 receives a data transfer request from a prescribed requester and proceeds to secure a network connection to the network 201, conduct macro access arbitration such that the memory module to be accessed is used effectively, and secure authorization to access the macro. Then, in consideration of the transfer timing, the transfer controller 203 directs the requester to transfer the data, sends switching information to the network, and sends a command to the memory module. The command sent to the memory module is for the access time (Read/Write) and the address (macro number, row number, and column number). Thus, the buffering that has heretofore been necessary to temporarily hold the data can be reduced. This reduction of buffering can be implemented even when the bandwidth of one channel of the network 201 and the band width of the memory module are not balanced, but the buffering can be eliminated when the bandwidth of one channel of the network and the band width of the memory module are equal.

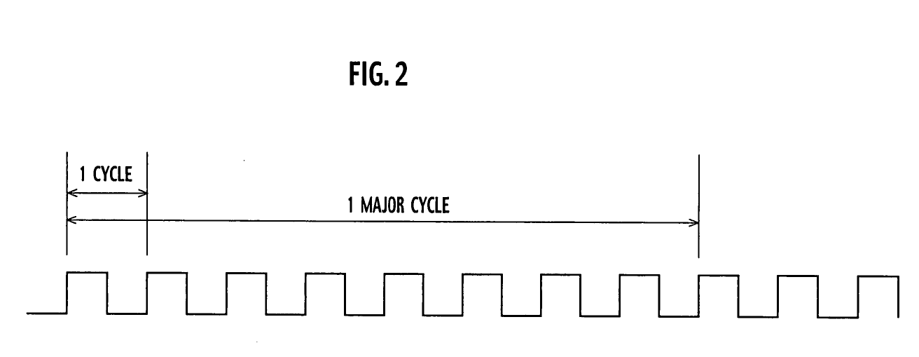

FIG. 2 is a diagram for explaining the major cycle. In this embodiment of the data transfer system, processing is executed and directives are issued based on a cycle called a “major cycle” in order to simplify the transfer processing and make it easier to pipeline the processing.

As shown in the figure, in this embodiment, one major cycle is defined to be eight regular clock cycles. By executing the processing on a per-major-cycle basis, the speed restrictions on the transfer controller can be loosened and design of the system becomes easier. By also executing data transfer on a per-major-cycle basis, the arbitration performed by the transfer controller and the actual transfer itself can be pipelined. For example, in the example shown in FIG. 2, the maximum burst size is 8 and eight cycles are consumed for data transfer even when the burst size is less than 8.

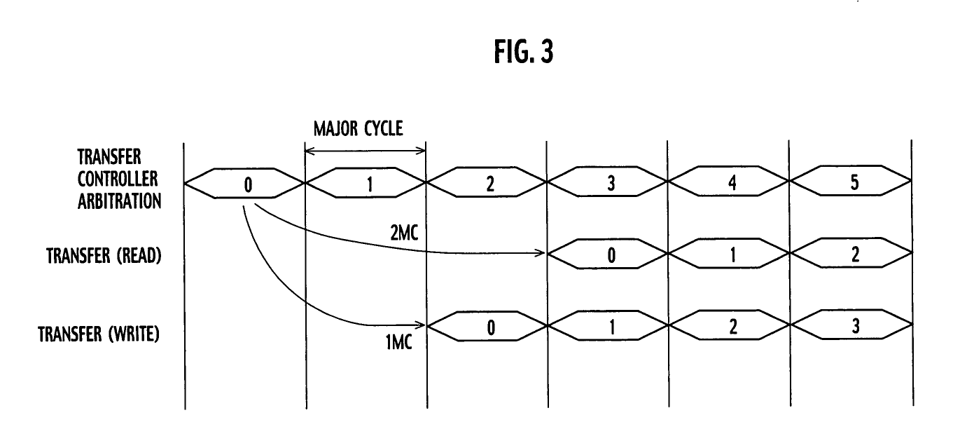

FIG. 3 is a diagram for explaining pipelining of the transfer processing using the major cycle. It will be assumed that the memory modules used in this embodiment require 16 cycles (tRD=16 cycles) to begin transferring read data after receiving the read command. Meanwhile, in the case of writing data, it will be assumed that the memory modules require 12 cycles (tWR=12 cycles) to actually begin accepting write data after receiving the write command. Thus, in FIG. 3, if the command “0” is the read command, then the arbitration executed by the transfer controller authorizes transfer in relation to that command two cycles later. Meanwhile, if the command “0” is a write command, transfer in relation to that command is authorized one cycle later. By thus pipelining the processing, the network can be used efficiently.

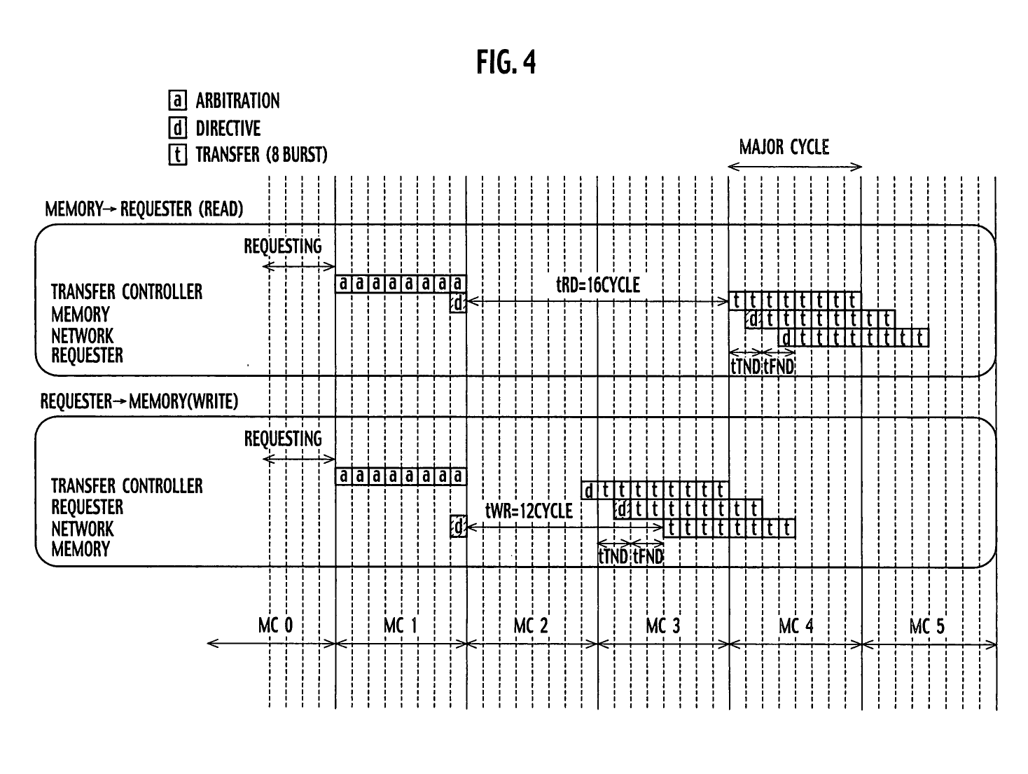

FIG. 4 is a timing chart for explaining the processing of each part of the data transfer system in this embodiment. The tTND indicates the delay to the network entrance, tFND indicates the delay from the network entrance, tRD indicates the time from when the memory module receives the read command until it begins transferring read data, and tWR indicates the time from when the memory module receives the write command until it begins accepting write data. The transfer controller receives a data transfer request from a requester at major cycle 0. Then, during major cycle 1, the transfer controller performs arbitration of the network and the memory module. The transfer controller issues directives to each resource at the timing described below when the network and memory resources have been secured.

The processing executed in a case where data is read from a memory module to a requester will now be described. First, the transfer controller receives a data transfer request during major cycle 0. If it receives a data transfer request during major cycle 0, the transfer controller performs arbitration during major cycle 1 and issues a read directive to the memory module at the end of major cycle 1 (i.e., at the position of major cycle 1 indicated with the letter “d”). Since the memory module requires two major cycles (tRD=16 cycles) to read out, the read data leaves the memory module at major cycle 4. Taking into account the delay required for the data to reach the network (tTND=two cycles in this embodiment), a directive is issued to the network at the second cycle of major cycle 4 (i.e., the position of major cycle 4 indicated with the letter “d”). Taking into account the delay required for the data to reach the requester from the network exit (tFND=two cycles), a data reception directive is issued to the requester at the fourth cycle of major cycle 4 (i.e., the position of major cycle 4 indicated with the letter “d”).

Next, the processing executed in a case where data is written to a memory module from a requester will be described. First, the transfer controller receives a data transfer request during major cycle 0. If it receives a data transfer request during major cycle 0, the transfer controller performs arbitration during major cycle 1 and issues a read directive to the memory module at the end of major cycle 1 (i.e., at the position of major cycle 1 indicated with the letter “d”). Since the memory module requires one major cycle (tWR=8 cycles) for data to be written thereto, the read data leaves the memory module at major cycle 3. Taking into account the cycle when the data will be put into the memory module, a transfer directive is issued to the requester at the last cycle of major cycle 2 (i.e., the position of major cycle 2 indicated with the letter “d”). Taking into account the delay required for the data to reach the network (tTND=two cycles in this embodiment), a switching information is set to the network at the second cycle of major cycle 3 (i.e., the position of major cycle 3 indicated with the letter “d”). The memory module receives the transferred data at the fourth cycle of major cycle 3 and the data is written to memory.

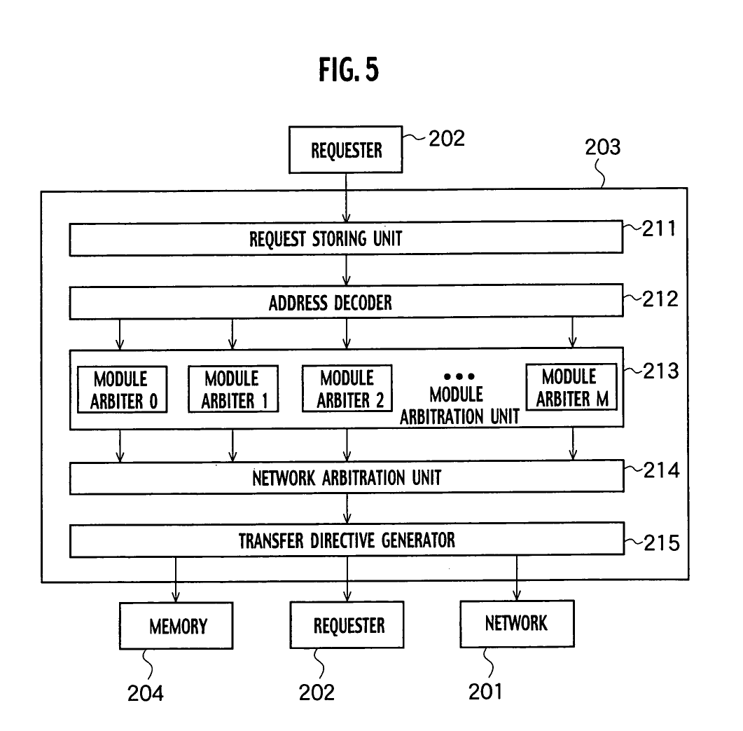

FIG. 5 is a block diagram for describing the details of the transfer controller of this embodiment. The transfer controller 203 includes the following: a request storing unit 211 that holds data transfer requests from the requesters 202; an address decoding unit 212 that decodes the addresses of the data transfer requests held in the request storing unit; a module arbitration unit 213 that performs arbitration of decoded data transfer requests on a per-module basis; a network arbitration unit 214 that performs arbitration for allocating the network to data transfer requests; and a transfer directive generating unit 215 that generates transfer directives related to data transfer requests that have been granted authorization to use the network by the network arbitration.

Now, the operation of the transfer controller will be described. First, the request storing unit 211 receives a data transfer request from a requester and holds the data transfer request in a request queue. The data transfer request includes information regarding the type of instruction, i.e., whether the data transfer request is a write instruction or a read instruction, and information regarding the address (target address) to which the processing is directed. Next, the address decoding unit 212 decodes the target address and extracts the memory module number and macro number from the request information. The module arbitration unit has module arbiters that hold decoded data transfer requests for each memory module number. The number of module arbiters provided equals the number of modules in the memory module. Each module arbiter selects the macro that can currently be accessed earliest among the macros specified in the data transfer requests held by that module arbiter. The module arbiters then use a round robin or other algorithm to select one data transfer request that will access the selected macro. The selected data transfer request is sent to the network arbitration unit 214. If the network is a multiple bus network and the number of data transfer requests set from the module arbiters exceeds the number of bus paths, then the network arbitration unit 214 performs arbitration again and allocates the bus to prescribed data transfer requests. With respect to data transfer requests that have obtained authorization to access a memory module and use the network, the transfer directive generator 215 sends directives to the requester, the network, and the memory module at such timings that the directives arrive and the data transfer can be accomplished indicated in FIG. 4.

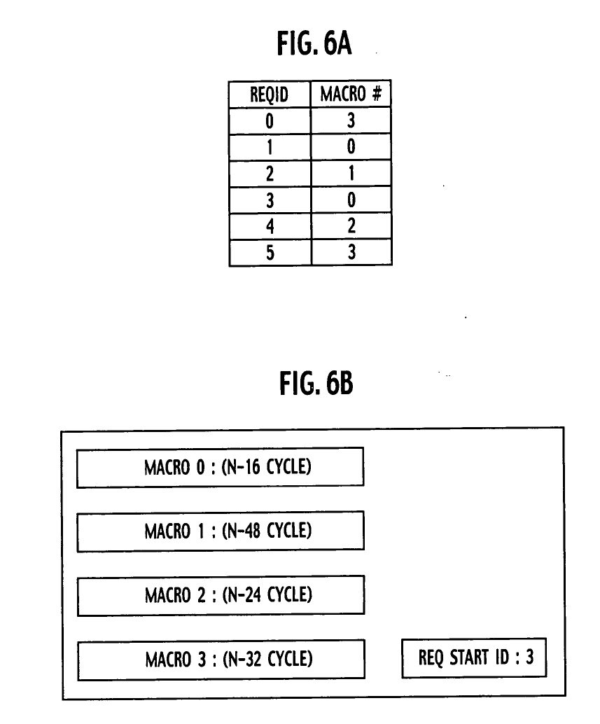

FIG. 6A shows a table of data transfer requests received from requesters and FIG. 6B serves to explain the processing executed by a module arbiter. The module arbitration unit 213 is provided with module arbiters corresponding to each module and the module arbiters perform arbitration in consideration of the tRC in order to use the memory modules effectively. Each module arbiter functions to select a macro that can be accessed from among the macros in the module it arbitrates, to select the requester having the highest priority right among the requesters that issued a data transfer request involving data transfer to the selected macro, and afterwards to update various information.

In the example shown in FIG. 6A, the requester whose request ID (reqid) is 0 is requesting a transfer to macro number 3, the requester whose reqid is 1 is requesting a transfer to macro number 0, the requester whose reqid is 2 is requesting a transfer to macro number 1, the requester whose reqid is 3 is requesting a transfer to macro number 0, the requester whose reqid is 4 is requesting a transfer to macro number 2, the requester whose reqid is 5 is requesting a transfer to macro number 3.

The information held by each module arbiter includes the time when access authorization was last granted and the request ID (ReqStartId) having the highest priority level for each macro. In the example shown in FIG. 6B, suppose that current time is time N, macro 0 was accessed 16 cycles previous to time N, macro 1 was accessed 48 cycles previous to time N, macro 2 was accessed 24 cycles previous to time N, and macro 3 was accessed 32 cycles previous to time N. The requester having the highest priority level is number 3 (ReqStartId=3).

Assuming tRC=32 cycles, the macros that can currently be accessed are macro 1 and macro 3. As shown in FIG. 6A, among the data transfer requests stored in the module arbiter, those that are requesting access to macro 1 and macro 3 are the requests having reqids 0, 2, and 5. Since the ReqStartId 3 is indicated in FIG. 6B, the requester having the highest priority level is the requester having the ID 3. Thus a list of the remaining requesters in order of descending priority level is as follows: the requester having the ID 4, the requester having the ID 5, the requester having the ID 6, the requester having the ID 0, the requester having the ID 1, and the requester having the ID 2. Consequently, in this embodiment, the requester that can access this memory module is the requester having the reqid 5. Next, the time when access to the macro 3 (which will be accessed by the requester having the reqid 5) was last granted is changed from N-32 to N and the ReqStartId is updated. It is also acceptable to handle the updating of the ReqStartId by incrementing it only when the requester having the highest priority has been granted authority to access the memory. For example, it is also acceptable to configure the module arbiter such that when the requester having the highest priority is the requester 4 (ReqStartId=4), the ReqStartId is only incremented from 4 to 5 when the requester having the ID 4 has been granted access authorization. These data updates are performed when access to the network has been obtained and scheduling has been completed.

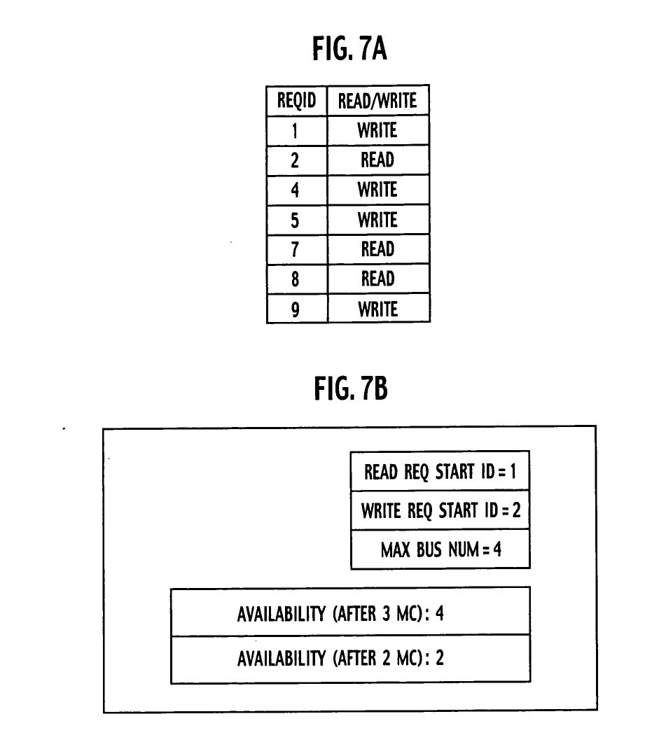

FIG. 7A shows a table of data transfer requests received from requesters and FIG. 7B serves to explain the processing executed by the network arbiter. Here, an example of a network arbiter for a multiple bus network is presented.

In this example, the number of buses is four. Data transfer requests that have been granted authorization to access a memory are sent to the network arbiter from the module arbiters As shown in FIG. 7A, the data transfer requests that have been granted authorization to access a memory are requesting read access or write access as follows: the requester whose reqid is 1 is requesting write access, the requester whose reqid is 2 is requesting read access, the requester whose reqid is 4 is requesting write access, the requester whose reqid is 5 is requesting write access, the requester whose reqid is 7 is requesting read access, the requester whose reqid is 8 is requesting read access, and the requester whose reqid is 9 is requesting write access.

The timing with which the network is used is different for reading than for writing, as explained previously. In this embodiment, the network is actually used two major cycles later in the case of writing and three major cycles later in the case of reading. Thus, the network arbiter needs to detect what the availability of the buses will be after two major cycles and after three major cycles. In this example, number of buses that will currently be available after two major cycles is two because two buses are already scheduled to be used by a read request that was issued one major cycle previous.

Similarly to the module arbiters, the network arbiter holds the identifiers ReadReqStartID and WriteReqStartID for assigning the priority level of read requests and write requests. In this embodiment, read requests and write requests are assigned to the network alternately.

First, one read request is assigned to the network. Since the ReadReqStartId is 1, the read request (Reqid=2) having the highest priority level is assigned to use the network three major cycles later and the number of available buses three major cycles later is decremented to three. Since the WriteReqStartId is 2, the write request (Reqid=4) having the highest priority level is assigned to use the network two major cycles later and the number of available buses is decremented to one. Bus assignments are made each major cycle.

Thus, read requests and write requests are assigned to the bus alternately until the number of open buses is zero or there are no more data transfer requests and lastly each StartId is incremented. Since write requests are assigned to use the bus two major cycles later and read requests are assigned to use the network three major cycles later, there is the possibility that processing of read requests will lag. Therefore, it is also acceptable to design the system such that a read request is assigned to use the bus three major cycles later whenever the WriteReqStartId becomes 0.

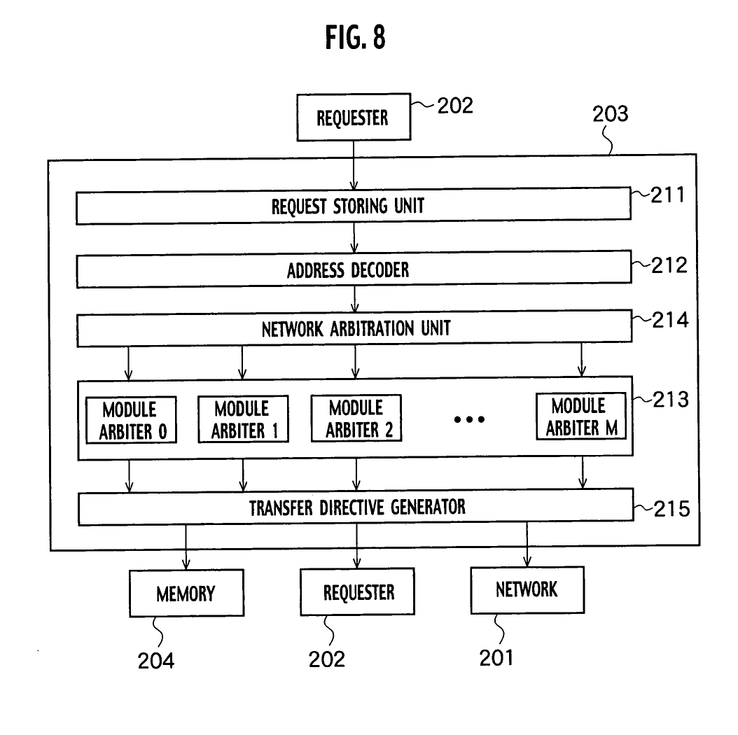

FIG. 8 is a block diagram for explaining the details of the transfer controller in a second embodiment. This transfer controller includes the following: a request storing unit 211 that receives data transfer requests from the requesters 202; an address decoding unit 212 that decodes the addresses of the data transfer requests held in the request storing unit; a network arbitration unit 214 that performs arbitration for allocating the network to data transfer requests; a module arbitration unit 213 that performs arbitration of data transfer requests selected by the network arbitration unit 214 on a per-module basis; and a transfer directive generating unit 215 that generates transfer directives related to data transfer requests that have been granted authorization to use the network by the network arbitration.

In this embodiment, network arbitration is performed first and then memory module arbitration is performed on data transfer requests that have already been authorized to use the network. Otherwise, this embodiment operates similarly to the example shown in FIGS. 7A and 7B.

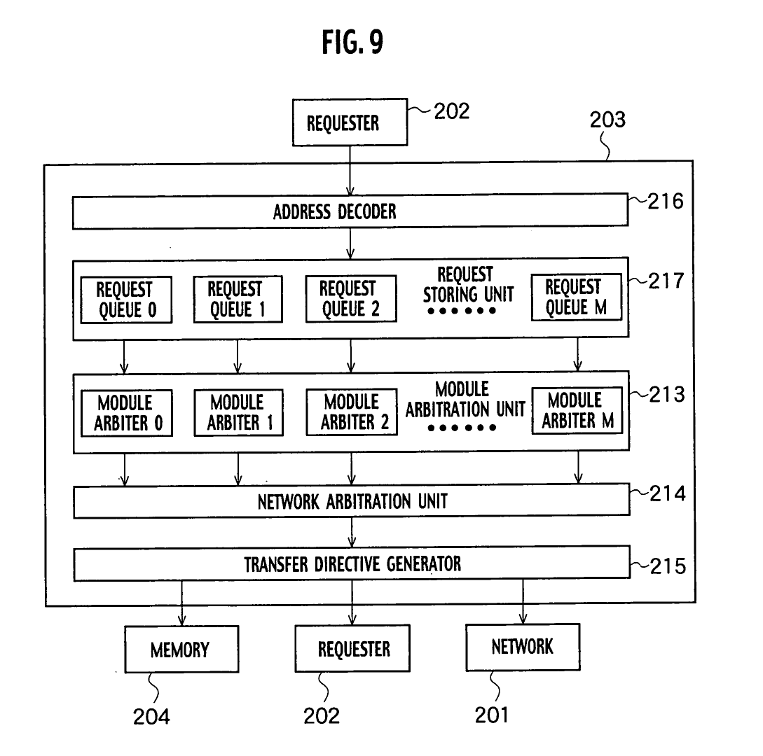

FIG. 9 is a block diagram for explaining the details of the transfer controller in a third embodiment. This transfer controller includes the following: an address decoding unit 216 that decodes the addresses of the data transfer requests from the requesters 202; a request storing unit 217 that holds decoded data transfer requests on a per-module basis; a module arbitration unit 213 that performs arbitration of data transfer requests held in the request storing unit 217 on a per-module basis; a network arbitration unit 214 that performs arbitration for allocating the network to data transfer requests; and a transfer directive generating unit 215 that generates transfer directives related to data transfer requests that have been granted authorization to use the network by the network arbitration.

In this embodiment, the address decoding unit 216 handles receiving the data transfer requests from the requesters as well as decoding the received data transfer requests. The request storing unit 217 has a separate request queue for each module and serves to hold decoded data transfer requests on a per-module basis. The module arbitration unit 213 receives instructions held in the request queues of the request storing unit 217 and performs arbitration on a per-module basis. Then, the network arbitration unit 214 performs network arbitration and the transfer directive generating unit 215 generates transfer directives. The transfer directives are sent to the memory modules, the requesters, and the network.

The processing executed by each unit of a data transfer system in accordance with the third embodiment can almost be described using the timing chart of FIG. 3, but here, assuming a data transfer request is received at major cycle 0, it is preferred that reception of the data transfer request be completed at least two or three cycles before the end of major cycle 0 in consideration of the time required for decoding.

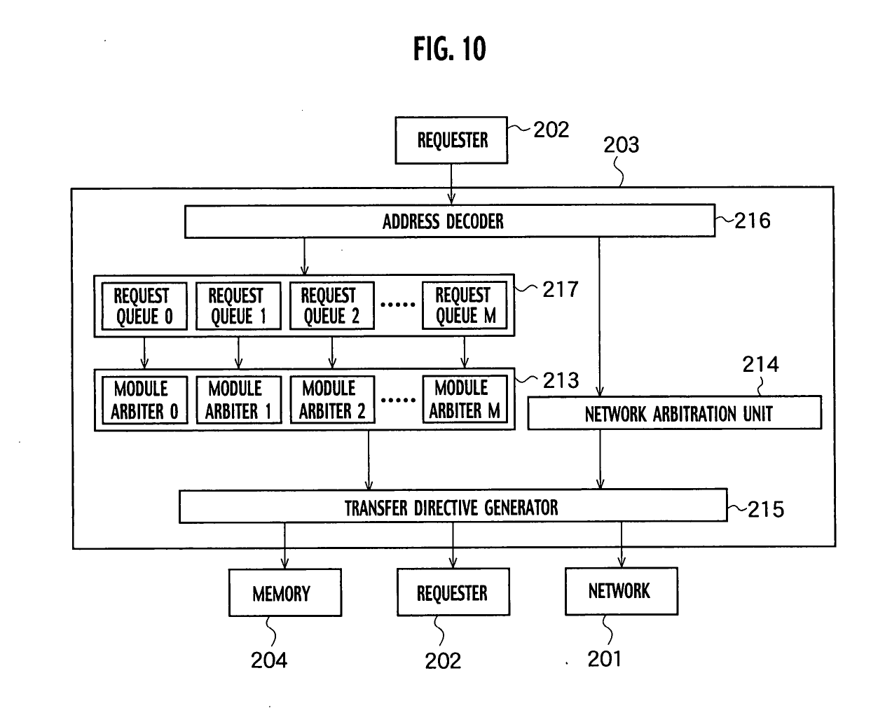

FIG. 10 is a block diagram for explaining the details of the transfer controller in a forth embodiment. As shown in FIG. 10, this transfer controller includes the following: an address decoding unit 216 that decodes the addresses of the data transfer requests from the requesters 202; a request storing unit 217 that holds decoded data transfer requests on a per-module basis; a module arbitration unit 213 that performs arbitration of data transfer requests held in the request storing unit 217 on a per-module basis; a network arbitration unit 214 that performs arbitration for allocating the network to decoded data transfer requests; and a transfer directive generating unit 215 that generates transfer directives related to data transfer requests that have been granted authorization to use the network by the network arbitration.

In this embodiment, the address decoding unit 216 handles receiving the data transfer requests from the requesters as well as decoding the received data transfer requests. The request storing unit 217 and the network arbitration unit 214 receive decoded data transfer requests. The network arbitration request storing unit 217 has a separate request queue for each module and serves to hold decoded data transfer requests on a per-module basis. The module arbitration unit 213 receives instructions held in the request queues of the request storing unit 217 and performs arbitration on a per-module basis. Meanwhile, the network arbitration unit 214 performs network arbitration with respect to the decoded data transfer requests. The transfer directive generating unit 215 generates transfer directives with respect to data transfer requests that were selected by both the module arbitration unit 213 and the network arbitration unit 214. The transfer directives are sent to the memory modules, the requesters, and the network. Thus, the processing executed by the module arbitration unit 213 and processing executed by the network arbitration unit 214 are performed in parallel, enabling the processing time to be shortened.

The processing executed by each unit of a data transfer system in accordance with the third embodiment can almost be described using the timing chart of FIG. 3, but here, assuming a data transfer request is received at major cycle 0, it is preferred that reception of the data transfer request be completed at least two or three cycles before the end of major cycle 0 in consideration of the time required for decoding.

Thus, by performing arbitration of the network and arbitration of the memory modules taking into account the control of the macros of the memory modules, a data transfer system in accordance with this embodiment makes it possible to perform scheduling at the cycle level and reduces or eliminates the need for a large-capacity intermediate buffer. Furthermore, by performing network arbitration in synchronization with the access timing of the memory modules, the network resources can be used effectively without occupying the network continuously in the conventional manner.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A data transfer system comprising:
a plurality of requesters configured to send data transfer requests, the requesters configured to transfer data when authorized;
a transfer controller configured to receive the data transfer requests from the requesters, the transfer controller configured to authorize one of the data transfer requests to perform arbitration for the data transfer requests, the transfer controller configured to send a transfer directive at a predetermined timing;
a network configured to receive the transfer directive to transfer data from an authorized requester based on the transfer directive; and
a plurality of memories including a plurality of modules, each of the modules having data input and output unit, the memories configured to receive the transfer directive to receive transfer data from the network based on the transfer directive.

2. The data transfer system as claimed in claim 1, wherein the transfer controller performs arbitration for the memories then performs arbitration for the network.

3. The data transfer system as claimed in claim 1, wherein the data transfer controller performs arbitration for the network then performs arbitration for the memories.

4. The data transfer system as claimed in claim 1, wherein the transfer controller performs arbitration for the network and arbitration for the memories in parallel.

5. The data transfer system as claimed in claim 1, wherein a data width of the network and data input and output width of the memories are equal.

6. The data transfer system as claimed in claim 1, wherein the transfer controller detects that the data transfer requests from the requesters are read access or write access, then the transfer controller controls the timing to send transfer directives based on the access.

7. The data transfer system as claimed in claim 1, wherein the plurality of modules includes a plurality of macros, the data is divided to be stored by the plurality of macros.

8. The data transfer system as claimed in claim 1, wherein the transfer controller controls transferring the data based on a major cycle defined to be at least two clock cycles.

9. The data transfer system as claimed in claim 1,the transfer controller further comprising:
a request storing unit configured to receive data transfer requests from the requesters;
an address decoder configured to decode addresses of the data transfer requests stored in the request storing unit;
a module arbitration unit configured to perform arbitrations of decoded data transfer requests on a per-module basis;
a network arbitration unit configured to perform arbitrations of the decoded data transfer requests for allocating the network; and
a transfer directive generator configured to generate transfer directives related to data transfer requests that is granted authorization to use the network by the module arbitration unit and network arbitration unit.

10. The data transfer system as claimed in claim 9, wherein the module arbitration unit includes a plurality of module arbiters that hold the decoded data transfer requests for each memory module.

11. The data transfer system as claimed in claim 10, wherein each of the module arbiters selects a macro that can currently be accessed earliest among the data transfer requests.

12. The data transfer system as claimed in claim 10, wherein each of the module arbiters selects a data transfer request requesting to an accessible macro based on the response time of the macro.

13. The data transfer system as claimed in claim 10, wherein each of the module arbiters receives priority information for transferring of the requesters to select a request having the highest priority among the data transfer requests.

14. The data transfer system as claimed in claim 9, wherein the network arbitration unit allocates, per a major cycle defined to be at least two clock cycles, a network connection of the network to requesters in consideration of read and write cycles based on the number of the buses of the network.

15. The data transfer system as claimed in claim 2, the transfer controller further comprising:
a request storing unit configured to receive data transfer requests from the requesters;
an address decoder configured to decode addresses of the data transfer requests stored in the request storing unit;
a module arbitration unit configured to perform arbitrations of decoded data transfer requests on a per-module basis;
a network arbitration unit configured to perform arbitrations of the decoded data transfer requests for allocating the network; and
a transfer directive generator configured to generate transfer directives related to data transfer requests that is granted authorization to use the network by the module arbitration unit and network arbitration unit.

16. The data transfer system as claimed in claim 15, wherein the module arbitration unit includes a plurality of module arbiters that hold the decoded data transfer requests for each memory module.

17. The data transfer system as claimed in claim 16, wherein each of the module arbiters selects a macro that can currently be accessed earliest among the data transfer requests.

18. The data transfer system as claimed in claim 16, wherein each of the module arbiters selects a data transfer request requesting to an accessible macro based on the response time of the macro.

19. The data transfer system as claimed in claim 16, wherein each of the module arbiter receives priority information for transferring of the requesters to select a request having the highest priority among the data transfer requests.

20. The data transfer system as claimed in claim 15, wherein the network arbitration unit allocates, per a major cycle defined to be at least two clock cycles, a network connection of the network to requesters in consideration of read and write cycles based on the number of the buses of the network.
